(19) United States
(12) Patent Application Publication
(10) Pub. No.: US 2012/0010993 A1
(43) Pub. Date: Jan. 12, 2012

(54) PROXIED CONSUMER E-COMMERCE TRANSACTIONS

(75) Inventors: Juan F. Ferrara, Stamford, CT (US); Pablo I. Illarramendi, Plantation, FL (US); Victor M. Nappe, Pompano Beach, FL (US)

(73) Assignee: MK TECHNOLOGY, LLC, Stamford, CT (US)

(21) Appl. No.: 12/832,039

(22) Filed: Jul. 7, 2010

(51) Int. Cl. G06Q 30/00; G06F 15/16

(52) U.S. Cl. 705/14.49; 709/217; 705/27.1; 705/26.1

(57) ABSTRACT

A method for proxied e-commerce transactions is provided. The method can include detecting establishment of a communicative session between a content browser of an end user and an e-commerce site for a merchant over a computer communications network. In response to the detection of the establishment of the communicative session, a pre-paid value of funds on account of the end user can be determined by a third party payment processor that is separate from the end user and the merchant. Also in response to the detection of the establishment of the communicative session, the pre-paid value can be transmitted to the merchant over the computer communications network to the merchant. Finally, a transaction for a product of the merchant can be processed by the third party payment processor on behalf of the end user using the funds on account of the end user.

### BACKGROUND OF THE INVENTION

1. Field of the Invention

The present invention relates to the field of e-commerce computing and more particularly to payment processing in an e-commerce computing environment.

2. Description of the Related Art

E-commerce computing refers to the offer, selection and purchase of products and services electronically over a computer communications network. Now part and parcel of the consumer experience, traditional e-commerce computing minimally requires the network distribution of a user interface to requesting consumers through which products or services can be listed and selected for purchase by the end user. Integral to any e-commerce system is an underlying payment processing module through which payment can be submitted by an end user for goods or services offered by a merchant, validated as proper and legitimate for the end user and reported to the merchant.

Initially, the traditional e-commerce environment required little other than the presentation of a selection of goods or service available for sale (collectively, “products”), and a simplistic data entry form into which the end user could supply basic payment information such as a credit card number and expiration date. The explosion of e-commerce, however, has resulted in such substantial volume of automated transactions that fraud with respect to payment processing has become commonplace and costly for merchants and payment processors alike. Consequently, substantial transaction processing has become requisite in e-commerce even for the most simple of commerce sites.

The overhead of payment processing in e-commerce has proven burdensome and expensive for merchants, and irritating and tedious for consumers. With respect to merchants, it is necessary not only to verify the identity of the consumer and the authenticity of the mode of payment presented to the merchant to pay for selected goods, but also it is necessary to validate available credit with respect to a presented form of payment. The costly transaction processing associated with the fraud detection workflow of the payment processor invariably is passed to the merchant in the form of fees and transaction costs thereby reducing margins and inhibiting profitability for the merchant. Further, consumers are compelled to provide substantial personally identifying information thus exposing consumers to online identity theft and a general loss of privacy.

Pre-paid modes of payment such as stored value cards provide some relief from the complexities and costs of payment processing in that the risk proposition for a payment processor is substantially reduced when funds are immediate and available in the pre-paid form of payment. To with, payment processors generally provide a reduced transaction fee to merchants when accepting forms of pre-payment and the necessity of collecting personally identifying information becomes reduced especially when only buying digital goods. Even still, some costs remain as well as the necessity at least to provide the most basic of identifying information to consummate an online purchase. For many consumers, the same sort of anonymity provided by the use of hard currency in a cash transaction at retail is preferred, or where the consumer is inclined to disclose little if any personally identifying information to the merchant.

### BRIEF SUMMARY OF THE INVENTION

Embodiments of the present invention address deficiencies of the art in respect to payment processing in e-commerce and provide a novel and non-obvious method, system and computer program product for proxied consumer e-commerce transactions. In an embodiment of the invention, a method for proxied e-commerce transactions can include detecting establishment of a communicative session between a content browser of an end user and an e-commerce site for a merchant over a computer communications network. In response to the detection of the establishment of the communicative session, a pre-paid value of funds on account of the end user can be determined by a third party payment processor that is separate from the end user and the merchant. Thereafter, the pre-paid value can be transmitted to the merchant over the computer communications network to the merchant. Finally, a transaction for a product of the merchant can be processed by the third party payment processor on behalf of the end user using the funds on account of the end user.

In one aspect of the embodiment, an advertisement for a product can be forwarded for display in the content browser of the end user from the e-commerce site of the merchant. Notably, the product can have a price determined to be less than or equal to the pre-paid value. In another aspect of the embodiment, the pre-paid value can be transmitted to the merchant over the computer communications network while concealing an identity of the end user from the merchant. In even yet another aspect of the embodiment, the processing of the transaction can include presenting a product offered for sale from the e-commerce site in a toolbar coupled to the content browser, receiving a selection by the end user to purchase the product offered for sale in the toolbar, transmitting a purchase request to the e-commerce server from the toolbar, populating a checkout form provided by the e-commerce server with data stored a the payment processor, and submitting the form on behalf of the end user by the payment processor.

In another embodiment of the invention, an e-commerce data processing system can include a computer with memory and at least one processor. The computer can be configured for communicative linkage to different e-commerce servers over a computer communications network. The system also can include a toolbar coupled to a content browser executing in the memory and a listener module coupled to the toolbar and the content browser. The listener module can include program code enabled to detect a session between the content browser and a registered one of the e-commerce servers, to determine in response to the detection a pre-paid value of funds on account of an end user associated with the content browser by a third party payment processor separate from the computer and the registered one of the e-commerce servers, and to transmit the pre-paid value to the registered one of the e-commerce servers over the computer communications network to the merchant. Optionally, a dynamic offer engine can be coupled to the toolbar and can include program code enabled to forward an advertisement for a product for display in the toolbar from the registered one of the e-commerce servers, such that the product has a price determined to be less than or equal to the pre-paid value.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for proxied consumer e-commerce transactions;

FIG. 2 is a schematic illustration of an e-commerce data processing system configured for proxied consumer e-commerce transactions; and,

FIG. 3 is a flow chart illustrating a process for proxied consumer e-commerce transactions.

### DETAILED DESCRIPTION OF THE INVENTION

Embodiments of the invention provide for a method, data processing system and computer program product for proxied consumer e-commerce transactions. In accordance with an embodiment of the invention, the establishment of a communicative connection between a content browser of an end user and an e-commerce server of a merchant over a computer communications network can be detected by an external payment processor. In response to detecting the establishment of the connection, available funds in the form of stored value for the end user can be communicated by the payment processor to the merchant through the e-commerce server, optionally while concealing an identity of the end user. Thereafter, a product or service of the merchant can be selected for purchase by the end user and the payment processor can process the purchase transaction using all or a portion of the available funds in the stored value as a proxy to the end user.

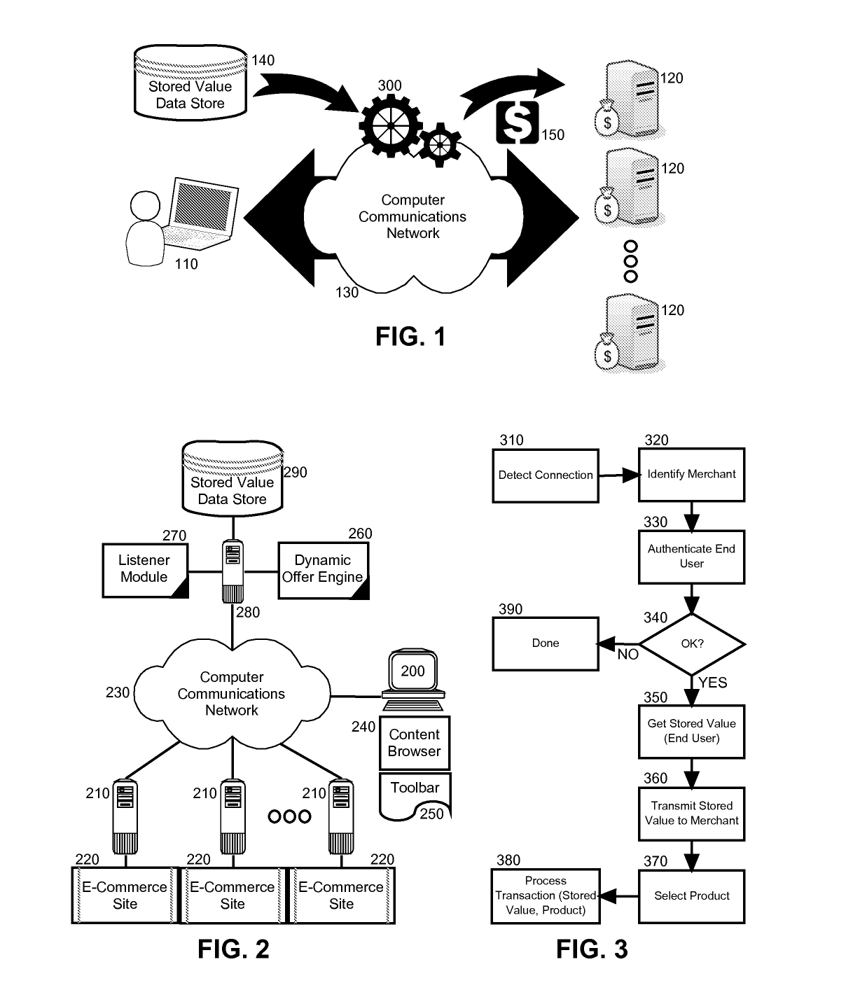

In further illustration, FIG. 1 pictorially shows a process for proxied consumer e-commerce transactions. As shown in FIG. 1, an end user 110 through a content browser such as a Web browser disposed in a computing device, such as a personal computer, personal digital assistant, smart phone, and the like, can establish a communicative link over computer communications network 130 with a selected e-commerce server 120 providing an e-commerce site through which products or services can be selected for purchase by the end user 110. An external payment data processing system 300 can detect the establishment of the communicative link, and in response, the external payment data processing system 300 can locate available funds set forth in stored value data store 140 for the end user 110 and can provide an indication of available funds 150 to the selected e-commerce server 120, optionally without revealing to the selected e-commerce server 120 the identity of the end user 110 so as to facilitate the anonymous purchase of goods or services from the selected e-commerce server 120.

Regardless, using the indication of available funds 150, the end user 110 can select goods or services from the selected e-commerce server 120 and the payment data processing system 300 can process the purchase of the selected goods or services using the available funds 150 without requiring additional payment processing (since the available funds 150 had been previously determined prior to the selection of the goods or services for purchase). Of note, in that the selected e-commerce server 120 enjoys a priori knowledge of the available funds 150, the selected e-commerce server 120 can provide targeted marketing of specific goods or services that are priced at or below the available funds 150. Alternatively, the payment data processing system 300 can query and promote specific goods or services of the merchant that are priced at or below the available funds 150 on behalf of the merchant. Consequently, the payment data processing system 300 can act as a dynamic affiliate network for the e-commerce servers 120.

The process described in connection with FIG. 1 can be implemented in a data processing system. In yet further illustration, FIG. 2 schematically depicts an e-commerce data processing system configured for proxied consumer e-commerce transactions. The system can include a host computing platform 280 of one or more servers, whether actual or virtual, each enjoying access to both memory and at least one processor, as well as fixed storage. The host computing platform 280 can be coupled to a stored value data store 290 of one or more tables of stored value data for different subscribing end users. The host computing platform 280 can be configured for communicative coupling to multiple different e-commerce servers 210 over computer communications network 230. Each of the e-commerce servers 210 in turn can provide an e-commerce site 220 including one or more user interface pages facilitating querying, browsing and payment processing of goods or services offered for sale by a merchant through the e-commerce site 220.

A listener module 270 can execute in the host computing platform 280. The listener module 270 can be configured with requisite computer usable program code to detect the establishment of a communicative link over the computer communications network 230 between a content browser 240 of an end user computer 200 and a selected one of the e-commerce sites 220. For example, the program code of the listener module 270 can be configured to monitor each subscribing one of the e-commerce sites 220 to detect the establishment of each session. Alternatively, the program code of the listener module 270 can be configured to monitor the activity of the content browser 240 to detect when a session is established with a subscribing one of the e-commerce sites 220.

In any event, the program code of the listener module 270 can be configured in response to detecting the establishment of the session between the content browser 240 and the selected one of the e-commerce sites 220, to identify an end user associated with the session and to locate available funds in the form of stored value in the stored value data store 290. The program code of the listener module 270 can be configured to subsequently transmit the available funds to the selected one of the e-commerce sites 220 prior to the selection by the end user of a product or service from the selected one of the e-commerce sites 220. Optionally, the identity of the end user can be withheld from the selected one of the e-commerce sites 220 so as to facilitate the anonymous purchase of goods or services by the end user from the selected one of the e-commerce sites 220. Finally, the program code of the listener module 270 can be configured to process a purchase transaction of one or more selected goods or services through the selected one of the e-commerce sites 220 using the available funds as a proxy to the end user.

In one aspect of the embodiment, a toolbar 250 can be coupled to the content browser 240, for example as a plug-in to the content browser 240. The toolbar 250 can be configured to communicate with the listener module 270 and to permit the display of the available funds, the selection of a product or service in the selected one of the e-commerce sites 220 and the direction to purchase the selected product or service so that the purchase can be managed remotely by the payment data processing system. Optionally, a dynamic offer engine 260 also can execute in the host computing platform 280 and can serve promotional information such as advertisements for display either in the content browser 240 or the toolbar 250 to the end user for one or more of the e-commerce sites. The promotional information can be selected to be consistent in pricing with the available funds and can be associated with products or services offered for sale not only by the selected one of the e-commerce sites 220, but also by others of the e-commerce sites 220.

In even yet further illustration of the process of purchasing products or services by proxy in the system of FIG. 2, FIG. 3 is a flow chart illustrating a process for proxied consumer e-commerce transactions. Beginning in block 310, the establishment of a communicative session can be detected as between the content browser of an end user and an e-commerce site of a merchant. In block 320, the merchant can be identified and in block 330, the end user can be authenticated into the payment processing system. In decision block 340, it can be confirmed that the end user has successfully authenticated into the payment processing system and that the merchant is a subscriber to the payment processing system. If not the process can end in block 390. Otherwise, the process can continue through block 350

In block 350, in response to the detection of the establishment of the communicative session, available funds in the form of stored value can be determined for the end user and in block 360, the available funds can be transmitted to the e-commerce site, however, as an option the identity of the end user can be withheld to preserve the anonymity of the end user when purchasing goods or services from the e-commerce site. Of note, the determination of available pre-paid funds and the transmission of the same to the e-commerce site can occur upon detecting the establishment of the communicative session and before a product can be selected by the end user for purchase. Thereafter, in block 370 one or more goods or services can be selected for purchase in the e-commerce site and in block 380, the purchase transaction of the selected goods or services can be consummated using the available funds by the payment processing system. In this way, the e-commerce site can be aware of an amount already cleared for use by a shopper in purchasing a product before the shopper begins shopping. The process of purchasing the selected goods or services can be managed entirely by the payment processor as proxy to the end user including auto-completing any purchase transaction form required by the e-commerce server, or by responding to the presentation of a form with a response string of requested transaction data as if the end user had manually completed the transaction form. To preserve the anonymity of the end user, purchaser identifying information can be omitted and payment can be guaranteed by the payment processor rather than the end user. Online delivery of electronic goods or services (such as downloadable imagery, audio or video, login information for consumer Web sites, or software) can be received in an intermediary mailbox managed by the payment processor as proxy to the end user.

As will be appreciated by one skilled in the art, aspects of the present invention may be embodied as a system, method or computer program product. Accordingly, aspects of the present invention may take the form of an entirely hardware embodiment, an entirely software embodiment or an embodiment combining software and hardware aspects that may all generally be referred to herein as a “module” or “system.” Furthermore, aspects of the present invention may take the form of a computer program product embodied in one or more computer readable storage medium(s) having computer readable program code embodied thereon. Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for proxied e-commerce transactions comprising:
detecting establishment of a communicative session between a content browser of an end user executing in memory by at least one processor of a computing device, and an e-commerce site for a merchant over a computer communications network;
determining in response to the detection of the establishment of the communicative session, a pre-paid value of funds on account of the end user by a third party payment processor that is separate from the end user and the merchant and transmitting in response to the detection of the establishment of the communicative session, an indication of the pre-paid value to the merchant over the computer communications network; and,
processing a transaction for a product from the merchant by the third party payment processor on behalf of the end user using the funds on account of the end user.

2. The method of claim 1, further comprising forwarding an advertisement for a product for display in the content browser of the end user from the e-commerce site of the merchant, the product having a price determined to be less than or equal to the pre-paid value.

3. The method of claim 1, wherein transmitting the pre-paid value to the merchant over the computer communications network to the merchant, comprises transmitting the pre-paid value to the merchant over the computer communications network to the merchant while concealing an identity of the end user from the merchant.

4. The method of claim 1, wherein processing a transaction for a product from the merchant by the third party payment processor on behalf of the end user using the funds on account of the end user, comprises:
presenting a product offered for sale from the e-commerce site in a toolbar coupled to the content browser;
receiving a selection by the end user to purchase the product offered for sale in the toolbar;
transmitting a purchase request to the e-commerce server from the toolbar;
populating a checkout form provided by the e-commerce server with data stored a the payment processor; and,
submitting the form on behalf of the end user by the payment processor.

5. The method of claim 4, wherein presenting a product offered for sale from the e-commerce site in a toolbar coupled to the content browser, comprises presenting a product offered for sale from the e-commerce site in a toolbar coupled to the content browser, the product having a price determined to be less than or equal to the pre-paid value.

6. An e-commerce data processing system comprising:
a computing device with memory and at least one processor and configured for communicative linkage to a plurality of different e-commerce servers over a computer communications network;
a toolbar coupled to a content browser executing in the memory; and,
a listener module coupled to the toolbar and the content browser, the listener module comprising program code enabled to detect establishment of a communicative session between the content browser and a registered one of the e-commerce servers, to determine in response to the detection of the establishment of the communicative session, a pre-paid value of funds on account of an end user associated with the content browser by a third party payment processor separate from the computer and the registered one of the e-commerce servers, and to transmit in response to the detection of the establishment of the communicative session, the pre-paid value to the registered one of the e-commerce servers over the computer communications network to the merchant

7. The system of claim 6, further comprising a dynamic offer engine coupled to the toolbar, the dynamic offer engine comprising program code enabled to forward an advertisement for a product for display in the toolbar from the registered one of the e-commerce servers, the product having a price determined to be less than or equal to the pre-paid value.

8. The system of claim 6, wherein the program code of the listener module is configured to transmit the pre-paid value to the registered one of the e-commerce servers over the computer communications network while concealing an identity of the end user from the registered one of the e-commerce servers.

9. A computer program product for proxied e-commerce transactions, the computer program product comprising:
a non-transitory computer readable storage medium having computer readable program code embodied therewith, the computer readable program code comprising:
computer readable program code for detecting establishment of a communicative session between a content browser of an end user and an e-commerce site for a merchant over a computer communications network;
computer readable program code for determining in response to the detection of the establishment of the communicative session, a pre-paid value of funds on account of the end user by a third party payment processor separate from the end user and the merchant and for transmitting in response to the detection of the establishment of the communicative session, the pre-paid value to the merchant over the computer communications network to the merchant; and,
computer readable program code for processing a transaction for a product from the merchant by the third party payment processor on behalf of the end user using the funds on account of the end user.

10. The computer program product of claim 9, further comprising computer readable program code for forwarding an advertisement for a product for display in the content browser of the end user from the e-commerce site of the merchant, the product having a price determined to be less than or equal to the pre-paid value.

11. The computer program product of claim 9, wherein the computer readable program code for transmitting the pre-paid value to the merchant over the computer communications network to the merchant, comprises computer readable program code for transmitting the pre-paid value to the merchant over the computer communications network to the merchant while concealing an identity of the end user from the merchant.

12. The computer program product of claim 9, wherein the computer readable program code for processing a transaction for a product from the merchant by the third party payment processor on behalf of the end user using the funds on account of the end user, comprises:
computer readable program code for presenting a product offered for sale from the e-commerce site in a toolbar coupled to the content browser;
computer readable program code for receiving a selection by the end user to purchase the product offered for sale in the toolbar;
computer readable program code for transmitting a purchase request to the e-commerce server from the toolbar;
computer readable program code for populating a checkout form provided by the e-commerce server with data stored a the payment processor; and,
computer readable program code for submitting the form on behalf of the end user by the payment processor.

13. The computer program product of claim 12, wherein the computer readable program code for presenting a product offered for sale from the e-commerce site in a toolbar coupled to the content browser, comprises computer readable program code for presenting a product offered for sale from the e-commerce site in a toolbar coupled to the content browser, the product having a price determined to be less than or equal to the pre-paid value.
